(19) United States
(12) Patent Application Publication
(10) Pub. No.: US 2009/0296054 A1
(43) Pub. Date: Dec. 3, 2009

(54) IMMERSION LITHOGRAPHY METHOD

(76) Inventors: Takuya KONO, Yokosuka-shi (JP); Masayuki HATANO, Yokohama-shi (JP)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 12/473,034

(22) Filed: May 27, 2009

(30) Foreign Application Priority Data
May 28, 2008 (JP) 2008-139543

(51) Int. Cl. G03B 27/52

(52) U.S. Cl. 355/30

(57) ABSTRACT

An immersion lithography method includes preparing an exposure tool having an exposure stage, a projection lens having an immersion head movable on the stage and used to form an immersion region and an illumination light source provided on the projection lens via a mask, placing a to-be-exposed substrate on the stage, supplying a liquid by use of the immersion head and forming the immersion region disposed between a surface portion of the substrate and a lower end portion of the projection lens, and relatively moving the stage and projection lens while holding the immersion region and exposing a region of the substrate covered with the immersion region. A first distance between the projection lens and the substrate is kept unchanged and a second distance between the immersion head and substrate is changed according to an exposure sequence.

### CROSS-REFERENCE TO RELATED APPLICATIONS

This application is based upon and claims the benefit of priority from prior Japanese Patent Application No. 2008-139543, filed May 28, 2008, the entire contents of which are incorporated herein by reference.

### BACKGROUND OF THE INVENTION

1. Field of the Invention

This invention relates to a photolithography technique used in a semiconductor device manufacturing process and more particularly to a scanning-type immersion lithography method for relatively moving an immersion region with respect to a to-be-exposed substrate and exposing the same.

2. Description of the Related Art

Recently, in order to cope with miniaturization of a semiconductor device pattern, a scanning-type immersion lithography exposure tool that performs an exposure process in a state in which a gap between the lower surface of a projection lens and the surface of a to-be-processed substrate is filled with a liquid such as water, for example, is actively developed (for example, see Jpn. Pat. Appln. KOKAI Publication No. 2008-21718). By using the immersion lithography exposure tool, the resolution limit and focusing depth can be enhanced without changing the exposure wavelength.

However, in this type of exposure tool, the following problems exist. That is, in the scanning-type immersion lithography exposure tool, an immersion region is locally formed on a to-be-exposed substrate and the exposure process is performed by use of the immersion region while it is relatively moved on the to-be-exposed substrate. In this case, in order to form a local immersion region, an immersion head is provided on the lower portion of the projection lens and the immersion region is moved together with the movement of the immersion head. A residual liquid occurs on the substrate surface at the movement time of the immersion head in some cases, and the occurrence of this residual liquid becomes particularly significant as the scanning velocity is increased. Further, when the immersion head moves a long distance on the to-be-exposed substrate or at the switching time of the scanning direction, residual liquid tends to occur. Therefore, a limit is imposed on the relative moving velocity of the immersion head and exposure stage and this acts as a factor of lowering the throughput.

Further, there occurs a problem that the scanning velocity is limited according to a coating material since the immersion holding ability of the immersion head varies according to a material such as a resist coated on the to-be-exposed substrate.

Therefore, it is desired to develop an immersion lithography method capable of suppressing the occurrence of residual liquid caused by an increase in the scanning velocity and enhancing the exposure throughput.

### BRIEF SUMMARY OF THE INVENTION

According to one aspect of the invention, there is provided an immersion lithography method, which includes:

preparing an exposure tool having an exposure stage, a projection lens having an immersion head formed to be movable on the exposure stage and used to form an immersion region and an illumination light source provided on the projection lens via a mask stage,

placing a to-be-exposed substrate on the exposure stage,

supplying liquid by use of the immersion head and forming the immersion region to be disposed between a surface portion of the to-be-exposed substrate and a lower end portion of the projection lens, and

relatively moving the exposure stage and projection lens while holding the immersion region and exposing a region of the to-be-exposed substrate that is covered with the immersion region,

wherein a first distance between the lower end portion of the projection lens and the surface portion of the to-be-exposed substrate is kept unchanged and a second distance between the lower end portion of the immersion head and the surface portion of the to-be-exposed substrate is changed according to an exposure sequence.

### BRIEF DESCRIPTION OF THE SEVERAL VIEWS OF THE DRAWING

FIG. 1 is a schematic structural view showing a scanning-type immersion lithography exposure tool according to a first embodiment of this invention.

FIG. 2 is a cross-sectional view showing the concrete structure of an immersion head used in the first embodiment.

FIGS. 3A to 3C are views showing the relation between an exposure region and an illumination slit region.

FIGS. 4A to 4C are views showing the relation between an exposure region and an illumination slit region.

FIG. 5 is a view showing the arrangement of a plurality of exposure regions formed on a to-be-exposed substrate.

FIG. 6 is an enlarged view of part of FIG. 5.

FIG. 7 is a view showing three states of an exposure sequence.

FIG. 8 is a flowchart for illustrating the operation of the first embodiment.

FIGS. 9A to 9C are views showing the relation of distances between an immersion head and a substrate surface for the respective sequences in the first embodiment.

FIG. 10 is a diagram showing the state of the relative movement of an immersion region and a to-be-exposed substrate, for illustrating a second embodiment of this invention.

FIGS. 11A to 11C are views showing the relation of distances between an immersion head and a substrate surface for the respective sequences in the second embodiment.

FIG. 12 is a view showing the relation between an immersion head and a to-be-exposed substrate, for illustrating a third embodiment of this invention.

### DETAILED DESCRIPTION OF THE INVENTION

Embodiments of the present invention will be described in detail below with reference to the accompanying drawings. In the following drawings, corresponding symbols are attached to corresponding portions and the same or similar portions are denoted by the same or similar symbols.

### First Embodiment

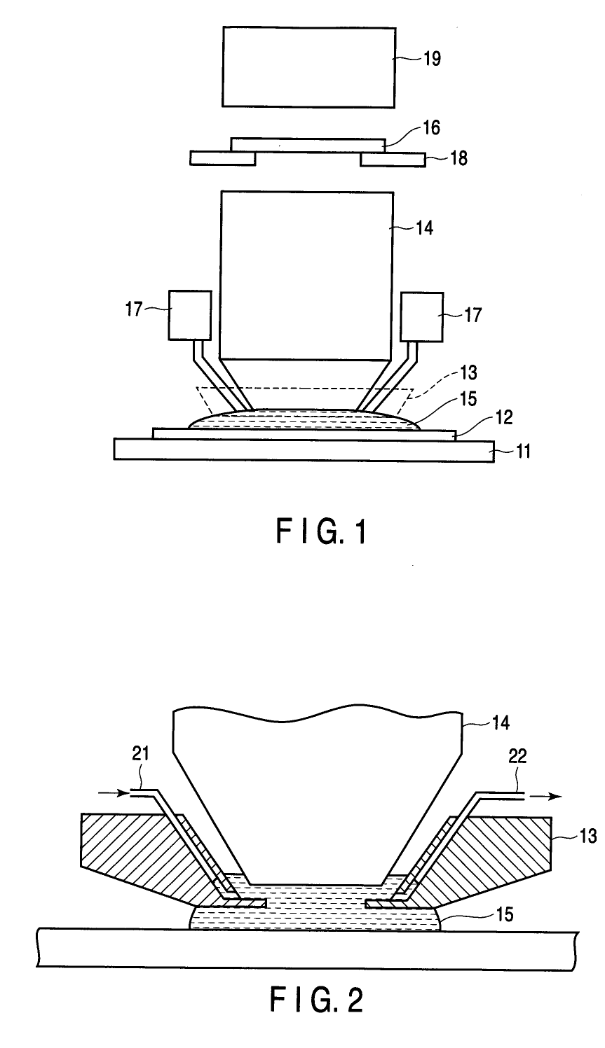

FIG. 1 is a schematic structural view showing a scanning-type immersion lithography exposure tool according to a first embodiment of this invention. The lithography exposure tool includes an exposure stage 11, immersion head 13, projection lens 14, water supply/collection mechanism 17, mask stage 18, illumination light source 19 and the like.

The exposure stage 11 is movable in an X direction (horizontal direction in the drawing) and Y direction (direction perpendicular to the drawing) and a to-be-exposed substrate 12 is placed on the stage 11. Thus, the to-be-exposed substrate 12 is also moved according to the movement of the exposure stage 11 in the horizontal direction. Like the exposure stage 11, the mask stage 18 is also movable in the X and Y directions and a photomask 16 having a design pattern such as a semiconductor device pattern formed thereon is arranged on the stage 18. Thus, the photomask 16 is also moved according to the movement of the mask stage 18 in the horizontal direction.

As shown in FIG. 2, the immersion head 13 is formed of a ring-shaped member provided to surround the lower end portion of the projection lens 14 and is mounted on the projection lens 14 to be vertically movable. The immersion head 13 is connected to a water supply tube 21 that supplies water into the central portion (the opening portion of the ring-shaped member) of the immersion head 13 and a discharging tube 22 that discharges water into the central portion. By supplying water into the central portion of the immersion head 13, an immersion region 15 is formed between the lower surface of the projection lens 14 and the surface of the to-be-exposed substrate 12. Further, in order to maintain the immersion region 15, water can be supplied/discharged in synchronism with scanning exposure by use of the water supply/collection mechanism 17.

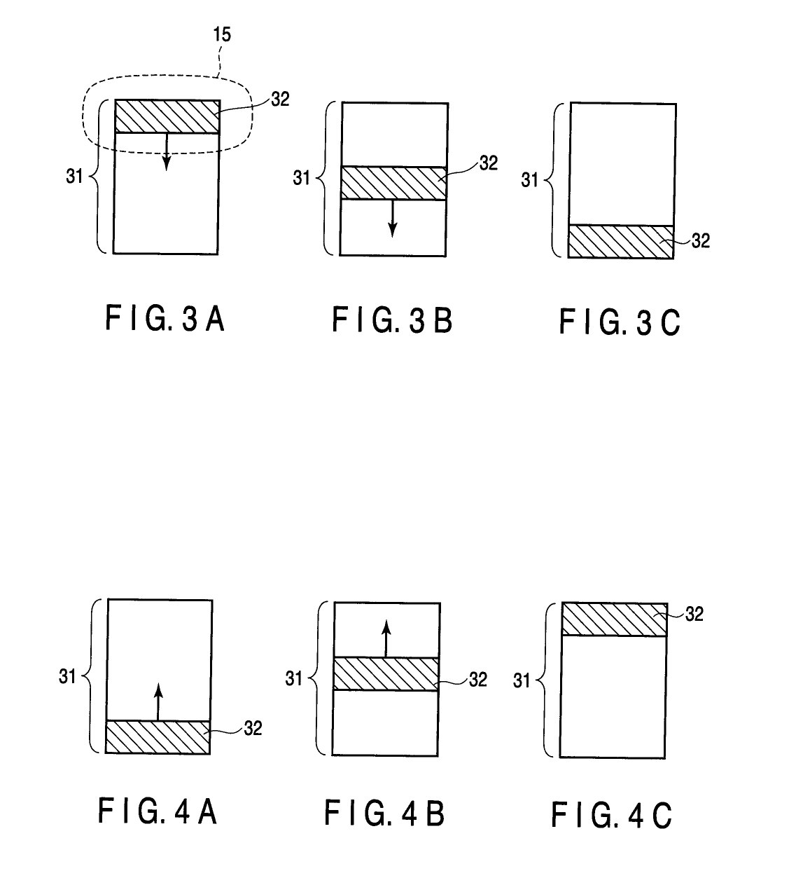

When exposure light is applied to the photomask 16 from the illumination light source 19, a mask pattern is projected and exposed to the surface of the to-be-exposed substrate 12 by the projection lens 14. At this time, water of the immersion region 15 is filled into a gap between the to-be-exposed substrate 12 and the projection lens 14, and exposure light emitted from the projection lens 14 passes through the layer of water of the immersion region 15 and reaches an illumination slit region 32 (illumination region) shown in FIG. 3A. FIG. 3A is a view showing the relation between the immersion region 15 and the illumination slit region 32 as viewed from above. The illumination slit region 32 is a slit-form region that is located at the center of the immersion region 15 and to which exposure light is actually applied, and the shape thereof is determined based on the slit provided in the illumination light source 19. Then, in the illumination slit region 32, an image of the mask pattern on the photomask 16 is projected onto the photoresist (not shown) on the surface of the to-be-exposed substrate 12 and a latent image is formed on the photoresist.

At the scanning exposure time, for example, as shown in FIGS. 3A to 3C, the illumination slit region 32 scans the exposure region 31 from the upper side to the lower side in the drawing by moving the exposure stage 11 and to-be-exposed substrate 12 in one direction with respect to the projection lens 14. Further, as shown in FIGS. 4A to 4C, the illumination slit region 32 scans the exposure region 31 from the lower side to the upper side in the drawing by moving the exposure stage 11 in a direction opposite to the above direction with respect to the projection lens 14.

At this time, since the upper surface of the immersion region 15 is kept in contact with the projection lens 14 and maintains the relation as shown in FIG. 1, the immersion region 15 moves along the to-be-exposed substrate 12 with the lower surface thereof kept in contact with the to-be-exposed substrate 12. Further, at the scanning exposure time, the photomask 16 is also simultaneously and horizontally moved together with the mask stage 18 in a preset direction with respect to the moving direction of the to-be-exposed substrate 12 while the exposure light is being applied thereto. The moving direction of the to-be-exposed substrate 12 and the moving direction of the photomask 16 are normally set to be opposite, although this depends on the configuration of a lens system.

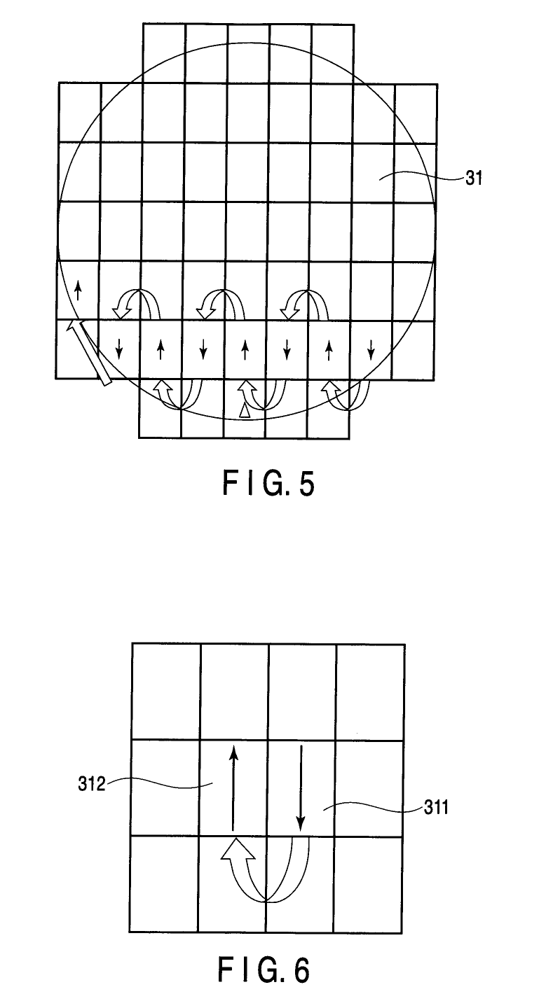

Next, an immersion lithography method using the scanning-type immersion lithography exposure tool of FIG. 1 is explained. The state of movement of the illumination region when a plurality of exposure regions on the to-be-exposed substrate 12 are sequentially scanned and exposed is shown in FIGS. 5 and 6. FIG. 5 shows the arrangement of a plurality of exposure regions 31 formed on the to-be-exposed substrate 12. A mask pattern drawn on one mask is projected onto the rectangular exposure region 31 on the to-be-exposed substrate 12 by scanning and exposing. FIG. 6 is an enlarged view of part of FIG. 5.

First, a first exposure region 311 of FIG. 6 is scanned and exposed. The illumination slit region 32 that starts scanning from the upper end of the first exposure region 311 reaches the lower end of the first exposure region 311 by moving the exposure stage 11 in one direction (first direction) (first exposing/moving step).

After this, the exposure stage 11 is moved from the position of the exposure stage 11 set when the illumination slit region 32 has reached the lower end of the first exposure region 311 to the position of the exposure stage 11 set when the illumination slit region 32 reaches the lower end of a second exposure region 312 while the moving direction thereof is changed (non-exposing/moving step). In this case, the first and second exposure regions 311 and 312 are adjacent to each other in a direction perpendicular to the scanning direction (first direction) in the first exposing/moving step.

If the illumination slit region 32 has reached the lower end of the second exposure region 312, then the second exposure region 312 is exposed while the exposure stage 11 is being horizontally moved in a direction (second direction) opposite to the direction set in the case wherein the first exposure region 311 is exposed (second exposing/moving step).

If the above exposing/moving operation is completed for one lateral row of exposure regions of the to-be-exposed substrate 12 as shown in FIG. 5, then the lateral row is changed to the directly upper lateral row, the above exposure operation is repeatedly performed and finally a scanning/exposing process is performed for all of the exposure regions on the to-be-exposed substrate 12.

The immersion region 15 that is set in contact with the projection lens 14 is relatively moved along the to-be-exposed substrate 12 accompanied by the movement of the exposure stage 11 and to-be-exposed substrate 12 in the first and second exposing/moving steps and non-exposing/moving step. In this case, immersion liquid tends to remain on the substrate surface when the moving direction of water that configures the immersion region 15 is changed or in a case where the relative movement extends over a long distance (several cm) in the relative movement of the immersion liquid 15 in the non-exposing/moving step that is the movement between the exposure regions.

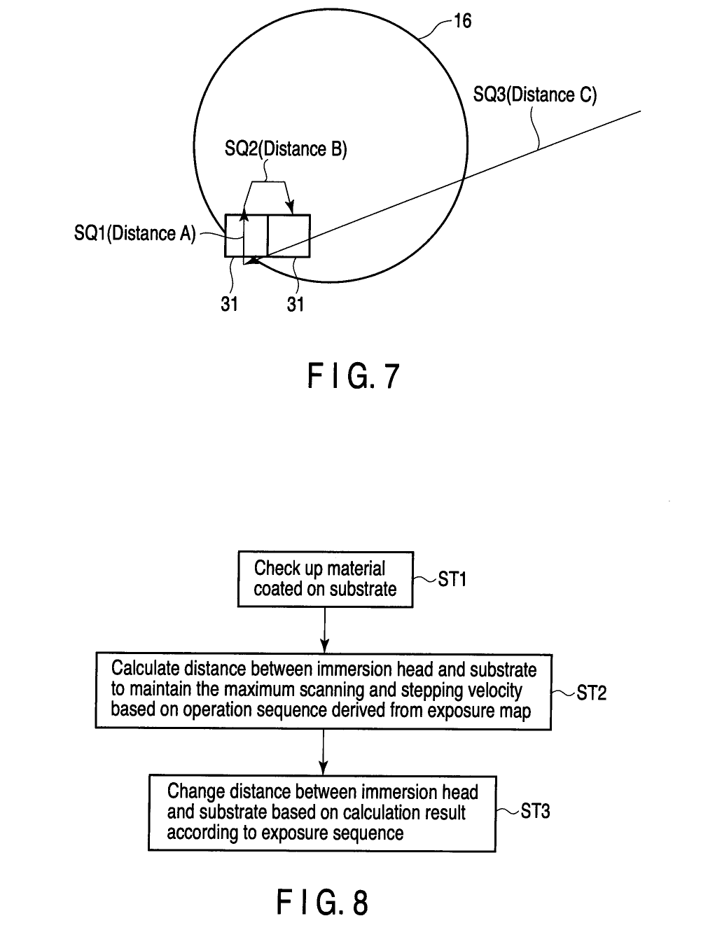

Next, a method for changing the distance between the immersion head and the to-be-exposed substrate according to an exposure sequence that is a feature of this invention is explained. FIG. 7 is a view showing three states of the exposure sequence.

Sequence 1 (SQ1) shows a state in which the exposure (scanning/exposing) process is actually performed while the exposure stage 11 is being continuously moved. Sequence 2 (SQ2) shows a state in which the exposure stage 11 is step-moved to a next exposure region 31 after completion of exposure of one exposure region 31. Sequence 3 (SQ3) shows a state in which the exposure stage 11 is moved from the exterior of the to-be-exposed substrate 12 to an exposure start point in the substrate 12. It is featured that the distance between the immersion head 13 and the to-be-exposed substrate 12 is changed for each exposure sequence.

FIG. 8 is a flowchart for illustrating the operation of this embodiment. In the scanning-type immersion lithography exposure tool, the water repellency, such as the contact angle with respect to immersion water of a material coated on the to-be-exposed substrate 12, is a main parameter that determines the scanning velocity that prevents residual liquid from occurring on the substrate surface at the moving time of the immersion head 13. Therefore, coating material information is acquired (ST1) and the respective operations based on the exposure map are checked according to the coating material information.

Specifically, the distance between the lower surface of the immersion head 13 and the surface of the to-be-exposed substrate 12 to maintain the maximum scanning/stepping velocity is calculated based on the coating material information for each sequence (ST2). Then, the exposure process is performed based on the calculation result while the distance between the lower surface of the immersion head 13 and the surface of the to-be-exposed substrate 12 is changed (ST3).

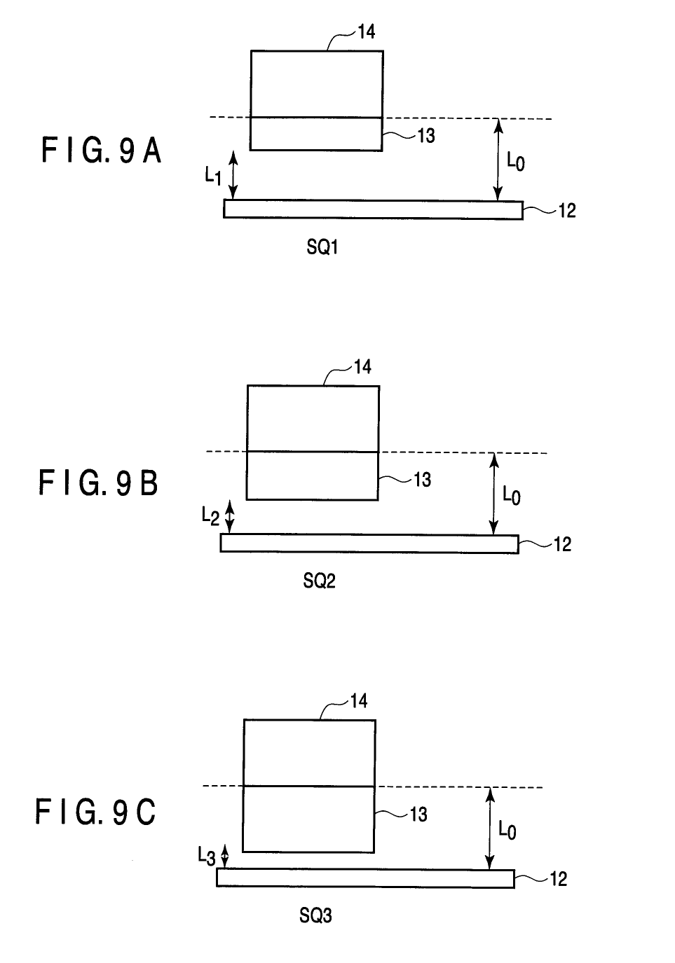

FIGS. 9A to 9C are views showing that the distance between the immersion head 13 and the substrate surface is different for each sequence. The distance L0 between the lower surface of the projection lens 14 and the surface of the to-be-exposed substrate 12 is kept constant irrespective of the sequences 1 to 3 (SQ1 to SQ3).

As shown in FIG. 9A, in the sequence 1 in which the exposure stage moves a short distance A at the scanning and exposing time, the distance L1 between the immersion head 13 and the substrate surface is set long. As shown in FIG. 9B, in the sequence 2 in which the exposure stage moves a relatively short distance B (B>A) when it is step-moved, the distance L2 between the immersion head 13 and the substrate surface is set shorter than L1. Further, as shown in FIG. 9C, in the sequence 1 in which the exposure stage moves a long distance C, the distance L3 between the immersion head 13 and the substrate surface is set shorter than L2.

Thus, according to this embodiment, the occurrence of residual liquid caused by the movement of the immersion head 13 can be previously prevented by setting the distance between the immersion head 13 and the substrate surface shorter as the continuous movement distance of the immersion head 13 becomes longer. That is, since the rate of occurrence of residual liquid is low in a case where the movement distance of the immersion head 13 is short, residual liquid does not occur even if the distance between the immersion head 13 and the substrate surface is set long. Further, the rate of occurrence of residual liquid becomes high in a case where the movement distance of the immersion head 13 is long. However, the immersion holding ability of the immersion head 13 can be enhanced by setting the distance between the immersion head 13 and the substrate surface short. As a result, occurrence of residual liquid can be prevented and occurrence of faults caused by occurrence of the residual liquid can be prevented.

In a case here the distance between the lower surface of the immersion head 13 and the surface of the to-be-exposed substrate 12 is set constant as in the conventional case, there occurs a possibility that residual liquid occurs when the immersion head 13 moves a long distance on the to-be-exposed substrate 12 or at the switching time of the scanning direction. In order to prevent this, a limit is imposed on the relative movement velocity of the immersion head 13 and exposure stage 11 and this causes a factor of lowering the throughput. In this embodiment, since occurrence of residual liquid can be prevented by setting the distance between the immersion head 13 and the substrate surface shorter as the movement distance of the immersion head 13 becomes longer, the relative movement velocity of the immersion head 13 and exposure stage 11 can be prevented from being limited. For example, the maximum scanning/stepping velocity can be maintained irrespective of a material coated on the substrate. As the result, the exposure throughput can be enhanced.

Generally, the rate of occurrence of residual liquid becomes lower as the distance between the lower surface of the immersion head 13 and the surface of the to-be-exposed substrate 12 is set shorter. However, in order to stably prevent the contact between the immersion head 13 and the to-be-exposed substrate 12 due to the movement of the projection lens for focusing or a fluctuation at the stage moving time, it is desired to separate the immersion head 13 and the substrate surface as far as possible from each other. In this embodiment, in order to set the distance between the immersion head 13 and the substrate surface shorter only when required, the probability of making contact between the immersion head 13 and the to-be-exposed substrate 12 can be made lower in comparison with a case wherein the distance is simply set short.

### Second Embodiment

In the first embodiment, the distance between the immersion head 13 and the substrate surface can be varied according to the continuous moving distance of the exposure stage 11, but the above distance may be varied according to the moving velocity of the exposure stage 11.

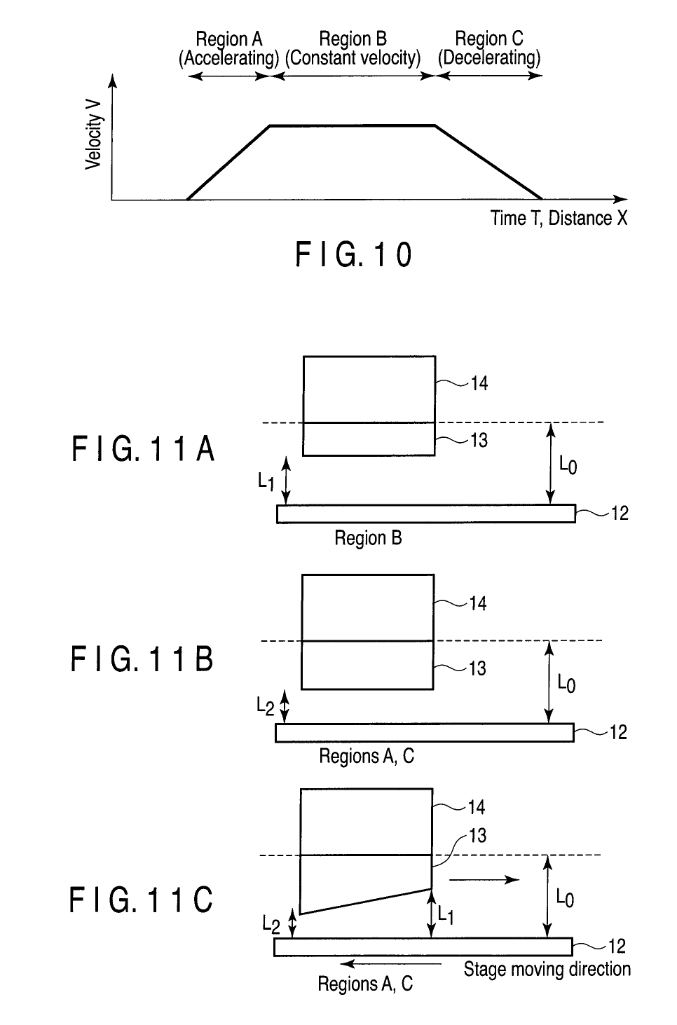

FIG. 10 shows the state of the relative movement of the immersion region 15 and the to-be-exposed substrate 12, that is, the state of movement of the immersion head 13 caused by the movement of the exposure stage 11. At the time of movement of the exposure stage 11, since the start and interruption of the stage movement will occur, the exposure stage 11 is not always moved at a constant velocity. As shown in FIG. 10, an acceleration region A is provided at the exposure start time, a constant velocity region B is provided at the exposure time and a deceleration region C is provided at the exposure termination time.

FIGS. 11A to 11C are views showing that the distance between the lower surface of the immersion head 13 and the surface of the to-be-exposed substrate 12 is different for each movement state of the immersion stage 13. The distance Lo between the lower surface of the projection lens 14 and the surface of the to-be-exposed substrate 12 is kept constant irrespective of the movement states of the immersion stage 13.

In the region B (constant velocity region) in which the exposure process is actually performed for the to-be-exposed substrate 12, the rate of occurrence of residual liquid caused by the movement of the immersion head 13 is low. Therefore, as shown in FIG. 11A, the distance L₁ between the immersion head 13 and the substrate surface is set relatively long. On the other hand, since the rate of occurrence of residual liquid caused by the movement of the immersion head 13 becomes high in the region A (acceleration region) or region C (deceleration region), the distance between the immersion head 13 and the substrate surface is set short as shown in FIG. 11B. At this time, a sequence of scanning movement is provided not only in the constant velocity region B but also in the acceleration region A and deceleration region C. Therefore, unlike the first embodiment, in this embodiment, the distance between the lower surface of the immersion head 13 and the surface of the to-be-exposed substrate 12 is not changed for each sequence but is changed in the same sequence.

Since the rate of occurrence of residual liquid is higher in the acceleration region A and deceleration region C in comparison with that in the constant velocity region B, occurrence of the residual liquid can be suppressed by setting the distance L2 between the immersion head 13 and the substrate surface in the acceleration region A and deceleration region C shorter than the distance L1 in the constant velocity region B as in this embodiment. Therefore, the same effect as that of the first embodiment can be attained.

Further, in order to suppress occurrence of the residual liquid, it is effective to enhance the immersion holding ability of the immersion head 13. For this purpose, the immersion head 13 may be inclined with respect to the moving direction of the immersion region 15 as shown in FIG. 11C. That is, the distance L2 between the substrate surface and the lower surface of the immersion head 13 on the rearward side in the moving direction is set shorter than the distance L1 between the substrate surface and the lower surface of the immersion head 13 on the forward side in the relative moving direction of the immersion head 13 with respect to the exposure stage 11. Thus, the immersion region 15 receives a force in the moving direction of the immersion head 13 and, as a result, the immersion holding ability of the immersion head 13 can be enhanced. Further, the distance L2 may be changed for the respective regions A, B and C in addition to inclination of the immersion head 13.

In a case where the immersion head 13 is moved in an opposite direction, the immersion holding ability can be enhanced at the time of movement in the opposite direction by reversing the inclination of the immersion head 13. Further, the to-be-exposed substrate 12 may be inclined instead of inclining the immersion head 13. Specifically, the stage 11 having the to-be-exposed substrate 12 placed thereon may be inclined so as to set the distance between the lower end portion of the immersion head 13 and the surface portion of the to-be-exposed substrate 12 shorter on the rearward side of the immersion head 13 in the moving direction than on the forward side.

Thus, according to the present embodiment, the occurrence of residual liquid caused by the movement of the immersion head 13 can be previously prevented by setting the distance between the immersion head 13 and the substrate surface to an optimum value according to the moving velocity of the immersion head 13. Further, the occurrence of residual liquid caused by the movement of the immersion head 13 can be previously prevented by inclining the immersion head 13 according to the moving direction of the immersion head 13. Therefore, the same effect as that of the first embodiment can be attained.

### Third Embodiment

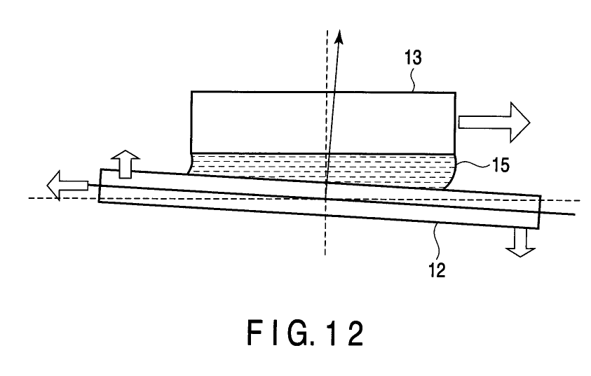

FIG. 12 shows the relation between an immersion head 13 and a to-be-exposed substrate 12, for illustrating a third embodiment of this invention.

The basic configuration of an exposure tool is the same as that of the first embodiment and the basic exposure operation is also the same as that of the first embodiment. This embodiment is different from the first embodiment in that an exposure stage 11 is inclined with respect to the horizontal plane at the scanning/moving time.

The to-be-exposed substrate 12 is inclined instead of inclining the immersion head 13 with respect to the moving direction of the immersion region shown in FIG. 11C. Specifically, the surface of the exposure stage 11 is inclined with respect to the horizontal plane so that the height position of the surface of the to-be-exposed substrate 12 may be set lower on the forward side than on the rearward side of the immersion head 13 in the relative moving direction with respect to the exposure stage 11. By performing an exposure process with the to-be-exposed substrate 12 thus inclined, immersion liquid lying on the rearward side of the immersion exposure region cannot remain on the immersion region 15 merely through the forces of surface tension and gravity.

The degree to which the immersion liquid remains is determined by the moving velocity of the immersion region 15 and hydrophilic property of the to-be-exposed substrate 12 with respect to the immersion liquid. The inclination angle of the to-be-exposed substrate 12 is changed according to the moving velocity of the immersion region 15 and hydrophilic property of the to-be-exposed substrate 12 without causing liquid dripping. Further, in a case where the relative moving direction of the immersion head 13 and exposure stage 11 is reversed, the inclination direction of the exposure stage 11 is reversed. Like the case of FIGS. 10, 11A and 11B in the second embodiment, the substrate may be horizontally set in the regions A, C and the distance L2 may be changed in addition to the process of inclining the exposure stage 11 at the scanning exposure time.

According to this embodiment, occurrence of residual liquid can be suppressed by inclining the surface of the to-be-exposed substrate 12 from the horizontal plane with respect to the moving direction of the immersion head 13 and the same effect as that of the first embodiment can be attained.

### Modification

This invention is not limited to the above embodiments. The shape of the immersion head is not limited to the structure shown in FIG. 2 and can be adequately modified according to the specification. Further, as a method for deriving the maximum scanning/stepping velocity of the immersion head, a method for determining and setting the same to a more preferable value according to not only a resist material coated on the to-be-exposed substrate but also the film thickness of a coating material, surface cleaning state, wafer edge processing state, wafer baking state and the like may be used.

The water repellency of the immersion head may vary according to the elapse of the service time thereof. In this case, the distance between the immersion head and the substrate surface may be varied according to variations in the water repellency of the immersion head. Further, the distance between the lower end portion of the immersion head and the surface portion of the to-be-exposed substrate may be varied according to a resist material coated on the to-be-exposed substrate.

As described above, according to the embodiments of this invention, occurrence of residual liquid caused by enhancing the scanning velocity can be suppressed and the exposure throughput can be enhanced by changing the distance between the lower end portion of the immersion head and the surface portion of the to-be-exposed substrate according to the exposure sequence without changing the distance between the lower end portion of the projection lens and the surface portion of the to-be-exposed substrate.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. An immersion lithography method comprising:
preparing an exposure tool having an exposure stage, a projection lens having an immersion head formed to be movable on the exposure stage and used to form an immersion region and an illumination light source provided on the projection lens via a mask stage,
placing a to-be-exposed substrate on the exposure stage,
supplying liquid by use of the immersion head and forming the immersion region to be disposed between a surface portion of the to-be-exposed substrate and a lower end portion of the projection lens, and
relatively moving the exposure stage and projection lens while holding the immersion region and exposing a region of the to-be-exposed substrate that is covered with the immersion region,
wherein a first distance between the lower end portion of the projection lens and the surface portion of the to-be-exposed substrate is kept unchanged and a second distance between the lower end portion of the immersion head and the surface portion of the to-be-exposed substrate is changed according to an exposure sequence.

2. The immersion lithography method according to claim 1, wherein the exposure sequence includes a first sequence of actually performing a scanning exposure process while continuously moving the exposure stage, a second sequence of step-moving the exposure stage to a next exposure region after completion of exposure of one exposure region and a third sequence of moving the exposure stage from an exterior of the to-be-exposed substrate to an exposure start point inside the substrate and the second distance is changed for each of the first, second and third sequences.

3. The immersion lithography method according to claim 2, wherein the second distance is determined according to a distance over which the exposure stage is step-moved at one time.

4. The immersion lithography method according to claim 2, wherein the second distance is determined according to a distance over which the projection lens is step-moved at one time.

5. The immersion lithography method according to claim 2, wherein the second distance is determined according to a distance over which the exposure stage is scanned.

6. The immersion lithography method according to claim 2, wherein the second distance is determined according to a distance over which the projection lens is scanned.

7. The immersion lithography method according to claim 2, wherein the second distance is determined according to a velocity at which the exposure stage is step-moved at one time.

8. The immersion lithography method according to claim 2, wherein the second distance is determined according to a velocity at which the projection lens is step-moved at one time.

9. The immersion lithography method according to claim 2, wherein the second distance is determined according to a velocity at which the exposure stage is scanned.

10. The immersion lithography method according to claim 2, wherein the second distance is determined according to a velocity at which the projection lens is scanned.

11. The immersion lithography method according to claim 2, wherein the immersion head is inclined to set the second distance shorter on a rearward side than on a forward side of the immersion head in a moving direction with respect to the to-be-exposed substrate.

12. The immersion lithography method according to claim 2, wherein the to-be-exposed substrate is inclined to set the second distance shorter on a rearward side than on a forward side of the immersion head in a moving direction with respect to the to-be-exposed substrate.

13. The immersion lithography method according to claim 2, wherein the second distance is changed according to a variation in water repellency of the immersion head.

14. An immersion lithography method comprising:
preparing an exposure tool having an exposure stage, a projection lens having an immersion head formed to be movable on the exposure stage and used to form an immersion region and an illumination light source provided on the projection lens via a mask stage,
placing a to-be-exposed substrate on the exposure stage,
supplying a liquid by use of the immersion head and forming the immersion region to be disposed between a surface portion of the to-be-exposed substrate and a lower end portion of the projection lens, and
relatively moving the exposure stage and projection lens while holding the immersion region and exposing a region of the to-be-exposed substrate that is covered with the immersion region,
wherein a surface of the to-be-exposed substrate is inclined with respect to a horizontal plane to set a position of the surface of the to-be-exposed substrate lower on a forward side than on a rearward side of the immersion region in a moving direction with respect to the surface.

15. The immersion lithography method according to claim 14, wherein the exposing the region covered with the immersion region includes a first sequence of actually performing a scanning exposure process while continuously moving the exposure stage, a second sequence of step-moving the exposure stage to a next exposure region after completion of exposure of one exposure region and a third sequence of moving the exposure stage from an exterior of the to-be-exposed substrate to an exposure start point in the substrate, the surface of the to-be-exposed substrate is inclined with respect to the horizontal plane in the first sequence and a facing distance between the lower end portion of the immerse head and the surface portion of the to-be-exposed substrate is changed in the second and third sequences.

16. The immersion lithography method according to claim 15, wherein the facing distance is determined according to a distance over which the exposure stage is step-moved at one time.

17. The immersion lithography method according to claim 15, wherein the facing distance is determined according to a distance over which the projection lens is step-moved at one time.

18. The immersion lithography method according to claim 15, wherein the facing distance is determined according to a velocity at which the exposure stage is step-moved at one time.

19. The immersion lithography method according to claim 15, wherein the facing distance is determined according to a velocity at which the projection lens is step-moved at one time.

20. The immersion lithography method according to claim 15, wherein the facing distance is changed according to a variation in water repellency of the immersion head.
